(19) United States
(12) Patent Application Publication
(10) Pub. No.: US 2011/0177452 A1
(43) Pub. Date: Jul. 21, 2011

(54) PRODUCTION METHOD OF TONER FOR DEVELOPING ELECTROSTATIC IMAGE

(75) Inventors: Yukio HOSOYA, Tokyo (JP); Mikio KOUYAMA, Tokyo (JP); Kenji HAYASHI, Tokyo (JP); Hiroaki OBATA, Tokyo (JP); Koji SHIBATA, Tokyo (JP)

(73) Assignee: KONICA MINOLTA BUSINESS TECHNOLOGIES, INC., Tokyo (JP)

(21) Appl. No.: 12/986,269

(22) Filed: Jan. 7, 2011

(30) Foreign Application Priority Data
Jan. 16, 2010 (JP) 2010-007604

(51) Int. Cl. G03G 9/08

(52) U.S. Cl. 430/137.14; 430/137.22

(57) ABSTRACT

A production method of a toner for developing an electrostatic image composed of toner parent particles and external additives adhered to a surface the toner parent particles is disclosed. The method includes steps of preparing toner parent particles dispersion liquid in which toner parent particles are dispersed in a medium, first mixing the dispersion liquid with a quaternary ammonium salt compound and a water soluble organic solvent to prepare liquid mixture, and second mixing the liquid mixture with external additive dispersion liquid in which negative charged external additives are dispersed.

This application is based on Japanese Patent Application No. 2010-007604 filed on Jan. 16, 2010, in Japanese Patent Office, the entire content of which is hereby incorporated by reference.

### TECHNICAL FIELD

The present invention relates to a production method a toner for developing an electrostatic image used for electrophotographic type image forming, hereafter, referred as a toner in abbreviation, and particularly relates to a production method of a toner for developing an electrostatic image specifying a method for adhering external additives to surface of toner parent particles.

### BACKGROUND

In a toner for developing an electrostatic image used for electrophotographic type image forming, inorganic microparticles or organic microparticles having particle diameter of several nm to several μm called external additives are adhered to surface of toner parent particles for improving and stabilizing fluidity or charging property. Adding method of external additives to surface of toner parent particles includes a dry process adhering external additives by adding mechanical impact force and a wet process adhering external additives to surface of toner parent particles in the presence of an organic solvent or aqueous solution of a surfactant, (for example, Patent Document 1 through 3).

External additives are adhered to surface of toner parent particles by giving mechanical energy mainly impact force under the condition in which external additives are supplied to toner parent particles subjected to drying process by process adhering external additives in a dry process, as described in for example, Patent Document 1. On the other side, in a process adhering external additives by the wet process, external additives are adhered to surface of toner parent particles by a process in which, for example, liquid dispersing external additives in an organic solvent or aqueous solution of a surfactant is mixed with liquid dispersing toner parent particles in aqueous solution of a surfactant, stirring process or the like, and an external force such as stirring process is given.

In recent years images having high level resolution, for example, 1,200 dpi (dot per inch) can be formed along with the development of digital technology of exposing system in the image forming apparatus. Attention is drawn to a production method of toner via polymerization process forming toner parent particles by polymerizing polymerizable monomers and simultaneously controlling the shape and particle size in the production process for a toner reproducing images of fine dots with fidelity. It is easy to prepare toner parent particles having uniform particle size and particle shape via polymerization process and it is preferable to reproduce images of fine dot with fidelity. The technology is examined in which external additives are added to surface of toner parent particles prepared via polymerization process via a wet process, for example, external additives are added to the surface of parent particles prepared via polymerization process in the technologies disclosed by above described Patent Documents 2 and 3. Patent Document 2 discloses a prepared by suspension polymerization process, which is one of the toner production processes by polymerization process, in which resin microparticles and inorganic microparticles having smaller particle size than the resin microparticles are respectively added to surface of toner parent particles externally. Patent Document 3 discloses external additives having reverse polarity to the toner parent particles are adhered uniformly to surface of the toner parent particles formed by polymerization of monomers having a polar group by utilizing an action of electrostatic attraction occurred between them.

### PRIOR ART DOCUMENT

### Patent Document

Patent Document 1: JP-A H02-090176
Patent Document 2: JP-A H05-341570
Patent Document 3: JP-A2005-172998

### SUMMARY OF THE INVENTION

### Problem to be Dissolved by the Invention

While it has become easy to prepare toner parent particles having uniform particle size and particle shape by the toner production via polymerization process as described above, it has found to be difficult considerably to adhere external additives to the surface of parent particles uniformly without unevenness by adding the external additives to the surface of prepared toner parent particles. The reason is considered that the surface is in difficult state to adhere the external additives uniformly such that dent portions exist on the surface even the toner parent particles prepared by polymerization process in case that the circularity is control to have irregular shape rather than true sphere in view of cleaning performance.

On the other side, from the view point of adhering method of external additives, for example, mechanical impact force is given to parent particles by employing a mixer or the like toner in the dry process. In this instance when there are dent portions on the surface of the particles, the external additives have a tendency to gather there, and it is difficult to cover uniformly and adhere with high adhering strength. Further there is a problem that toner parent particles coagulate mutually set to have lower glass transition temperature or softening point temperature in the toner for measuring low fixing temperature, since external additives are usually adhered at the temperature circumstances higher than mom temperature.

Moreover, it is difficult to give sufficient adhering force to the external additives by only the electrostatic attraction action in the wet process disclosed in above described Patent Documents 2 or 3, and additional process such as thermal processing is required. Further a process is necessary to give a sufficient charge to the surface of toner parent particles for adhering external additives uniformly. Though a method to give charge via a surfactant to toner parent particles in the dispersion liquid, the expected effects are not obtained. Further, when there are dent portions on the surface of the particles, the external additives have a tendency to gather there.

The technology to cover the external additives on the surface of toner particles prepared via polymerization process and to adhere with high adhering strength is not established sufficiently as described above.

The object of the present invention is to provide a technology to cover the external additives on the surface of toner parent particles uniformly and to adhere with high adhering strength. Practically, the object is to provide a production method of a toner for developing an electrostatic image by covering the surface of toner parent particles dispersed with external additives in an aqueous medium, capable of adhering with high adhering strength, whereby the toner exhibiting excellent fluidity and charging performance is obtained.

### Technical Means to Dissolve the Problem

The inventors have found that the above described objects attained by the following aspects, that is, the invention described in claim 1 is that;

a production method of a toner for developing an electrostatic image comprising a process of forming toner particles by adhering external additives to surface of toner parent particles at least, in a mixture liquid of dispersion liquid dispersing negative charged external additives and dispersion liquid dispersing toner parent particles, wherein at least a quaternary ammonium salt compound and a water soluble organic solvent are added to above described dispersion liquid dispersing toner parent particles and the negative charged external additives are adhered to surface of the toner parent particles.

The invention described in claim 2 is that,

The production method of a toner for developing an electrostatic image described in claim 1, wherein above described toner parent particles are formed by, in an aqueous medium, aggregating and fusing at least resin particles which are formed by polymerizing polymerizable monomers in an aqueous medium.

The invention described in claim 3 is that,

The production method of a toner for developing an electrostatic image described in claim 1 or 2, wherein above described dispersion liquid dispersing negative charged external additives contains an anionic surfactant.

The invention described in claim 4 is that,

The production method of a toner for developing an electrostatic image described in any one of claims 1 to 3, wherein above described water soluble organic solvent has lower dielectric constant than that of water.

The invention described in claim 5 is that,

The production method of a toner for developing an electrostatic image described in any one of claims 1 to 4, wherein adding amount of above described water soluble organic solvent is not less than 3% by mass and not more than 30% by mass.

### Benefit of the Invention

The invention makes possible to provide technology realizing to adhere external additives on the surface of toner parent particles with uniform covering and high adhesion strength in an aqueous medium. That is, it is found that the above described problems are dissolved by employing dispersion liquid of toner parent particles containing a quaternary ammonium salt compound and water soluble organic solvent when the external additives are adhered by mixing dispersion liquid of negative charged external additives and dispersion liquid of toner parent particles.

It becomes possible to adhere the external additives to surface of toner parent particles prepared via polymerization process with high adhesion strength as well as to produce a toner for developing an electrostatic image having excellent fluidity and charging performance as the result, as illustrated by the description in examples described later.

### BRIEF DESCRIPTION OF DRAWING

FIG. 1: A schematic view of parts feeder used in the measurement of transfer index of toner.

### EMBODIMENT TO PRACTICE THE INVENTION

A practical embodiment of the invention is described in detail hereafter. The term of “toner parent particles” used in the invention means resin particles as raw material of the toner employed in the electrophotographic type image forming, and the particles in the state prior to addition of external additives. The term of “toner particles” used in the invention means the particles which are available to use in electrophotographic type image forming by adding the external additives to surface of the previously described “toner parent particles”. Further the term of “toner” used in the invention means bulk of previously described “toner particles”, which is, for example, contained in a cartridge installed in a printer to employ in the image forming.

In a production method of the toner for developing an electrostatic image according to the invention (referred to also toner in abbreviation hereafter) toner particles are formed by adhering external additives to surface of toner parent particles in a mixture liquid of at least dispersion liquid dispersing negative charged external additives and dispersion liquid dispersing toner parent particles. And the dispersion liquid of toner parent particles contains a quaternary ammonium salt compound and a containing water soluble organic solvent.

A quaternary ammonium salt compound and water soluble organic solvent are add to dispersion liquid dispersing toner parent particles, and surface of toner parent particles is charged in reversed polarity to surface charge of the external additives by the quaternary ammonium salt. And an electrical double layer is compressed by means of water soluble organic solvent, and environment to easily adhere the external additives particles to the surface of toner parent particles is formed. Addition of the quaternary ammonium salt compound and water soluble organic solvent to the toner parent particles in the dispersion liquid may be conducted simultaneously or separately irrespective of its order, and it is preferable to add simultaneously or add the quaternary ammonium salt compound previously so that the quaternary ammonium salt compound is effectively adsorbed to the surface of toner parent particles. Further, dispersion liquid dispersing negative charged external additives is employed in the invention. Practical means to negatively charge the external additives includes, as a representative example, a method to add a surfactant such as dodecylbenzenesulfonic acid in the dispersion liquid. It is possible to use inorganic microparticles dispersion liquid such as colloidal silica dispersion liquid available from market, and in this instance, it is preferable that pH in the dispersion liquid is adjust to 4 (isoelectric point) or higher to give negative charge to inorganic microparticles.

Thus the toner particles are produced by mixing dispersion liquid of negative charged external additives and dispersion liquid of positively charged toner parent particles by means of addition of a quaternary ammonium salt and water soluble organic solvent, whereby external additives are allowed to cover on surface of said toner parent particles uniformly, and to adhere with high adhering strength in the invention.

It is presumed external additives adhere uniformly on surface of toner parent particles by forming the environment as described below in the mixture liquid of dispersion liquid above described external additives and dispersion liquid of toner parent particles.

(1) Surface of toner parent particles becomes to have reversed polarity to external additive particles which is charged negatively as a quaternary ammonium salt is add to dispersion liquid of toner parent particles, whereby electrostatic attraction works between the toner parent particles and external additives particles, and therefore, the external additives adsorb electrostatically and adhere irrespective of shape of the surface of toner parent particles uniformly.
(2) Toner parent particles maintain stable dispersion state in the mixture liquid and repulsive force of an electrical double layer acting between toner parent particles and dispersion medium becomes small by existing of water soluble organic solvent, environment in which external additives easily adhere uniformly on surface of toner parent particles is formed. Further, it is presumed to become possible to control the adhesion strength to surface of toner parent particles by adjusting spices of organic solvents and its adding amount when water soluble organic solvent is a water soluble organic solvent which has lower dielectric constant then water, it reduces repulsive force of the electrical double layer formed on the dispersed particles, and it is possible to allow the adhering speed higher.

It is presumed that it becomes possible that external additives adhere to the surface of toner parent particles uniformly without unevenness by forming such environment. Consequently, it is presumed that when toner parent particles even have dents or cracks on the surface, external additives do not deposit on these sites and it makes possible to adhere on the surface of toner parent particles uniformly. Further, it is presumed that amount of used external additives when external additives are adhered to surface of toner parent particles can be reduced.

Repulsive force of electrical double layer previously described is presumed to become smaller by the following reason.

Repulsive force is generated between toner parent particles and water composing molecule dispersion medium by forming electrical double layer between toner parent particles and dispersion medium in the dispersion liquid.

Toner parent particles can maintains stable dispersion state without occurring sedimentation or coagulation in the dispersion medium by the act of repulsive force, and the thicker the electrical double layer, the stronger the repulsive force becomes and the dispersion state becomes more stable. On the other side, the electrical double layer becomes thicker, there is a tendency that it becomes difficult to take the component in the dispersion medium on surface of particles as the repulsive force works stronger, for example, operation and the like to adhere external additives on the surface of toner parent particles becomes difficult.

The thickness of the electrical double layer depends on dielectric constant ∈ of dispersion medium, and the larger dielectric constant of the dispersion medium is, the electrical double layer becomes thicker and in opposition, the lower dielectric constant becomes, the thinner the electrical double layer becomes. It is presumed that an organic solvent having lower dielectric constant than water is allowed to exist in dispersion medium, the repulsive force is reduced by making thickness of the electrical double layer formed between toner parent particles and dispersion medium in a degree causing no damage on dispersion stability of the particles in the invention. As the result, ingredient such as external additives and a surfactant in the dispersion medium becomes approach to surface of toner parent particles easily, and uniform charging on the surface of toner parent particles and uniform adhere of external additives become possible.

Dispersion liquid dispersing toner parent particles and dispersion liquid dispersing negative charged external additives used in the invention are described below in detail. First, dispersion liquid dispersing toner parent particles used in the invention is described.

Dispersion liquid dispersing toner parent particles is mixed with a quaternary ammonium salt compound and water soluble organic solvent.

A quaternary ammonium salt compound imparting positive charge to toner parent particles and water soluble organic solvent are described here.

The quaternary ammonium salt compound capable of mixing with dispersion liquid dispersing toner parent particles in the invention is one of cationic surfactant, for example, and includes alkyltrimethyl ammonium chloride, dialkyldimethyl ammonium chloride and the like. The quaternary ammonium salt compound imparts positive charge to toner parent particles particularly among the cationic surfactants, and can cover the surface of toner parent particles uniformly by employing small particle diameter external additives having small negative charge.

Practical examples of the quaternary ammonium salt compound available to use in the invention include the following, alkyltrimethyl ammonium chloride, such as lauryltrimethyl ammonium chloride (trade name of QUARTAMINE 24P, product by Kao Corp.), stearyl trimethyl ammonium chloride, cetyltrimethyl ammonium chloride, and the like, and dialkyldimethyl ammonium chloride such as distearyl dimethyl ammonium chloride and the like. Practical examples of the quaternary ammonium salt compound include allkylbenzyl dimethyl ammonium chloride, pyridinium chloride, alkylisoquinolium chloride, chloride and the like.

It is possible to use amine salt type surfactants which can charge the surface of toner parent particles positive such as alkyl amine salt, aminoalcohol aliphatic acid derivative, polyamine aliphatic acid derivative, imidazoline and the like in combination with the quaternary ammonium salt compound described above in the invention.

An amount of the quaternary ammonium salt compound mixed with the toner parent particles dispersion liquid is preferably 1% by mass to 20% by mass, and more preferably 3% by mass to 10% by mass based on the dispersion medium of the toner parent particles dispersion liquid. It is preferable as charge can be imparted certainly and effectively on the surface of toner parent particles in the dispersion liquid by setting the adding amount to in the dispersion medium above described range to realize uniform covering external additives.

Water soluble organic solvent capable to add to dispersion liquid dispersing toner parent particles in the invention includes water soluble alcohols and ketones. Practical example of water soluble alcohols includes, for example, methanol, ethanol, isopropyl alcohol, n-propanol and the like. Practical example of water soluble ketones includes, for example, acetone, methylethylketone and the like.

These water soluble organic solvents have dielectric constant lower than that of water (78.3 at 25° C.), practically, alcohols such as, methanol (32.6 at 25° C.), ethanol (24.3 at 25° C.), isopropyl alcohol (19.9 at 25° C.)., ketones such as acetone (20.7 at 25° C.), methylethyl ketone (18.5 at 20° C.). The value in the parenthesis ( ) shows the dielectric constant at each temperature.

An amount of the water soluble organic solvent mixed with the toner parent particles dispersion liquid is preferably 3% by mass to 30% by mass, and more preferably 5% by mass to 20% by mass based on the dispersion medium of the toner parent particles dispersion liquid. It is preferable to set adding amount to the water soluble organic solvent in the range as above described, advantage by addition of the organic solvent previously described is displayed, and uniform covering and adhesion with high adhesion strength of the external additives on the surface of toner parent particles can be conducted certainly and effectively. Further it is preferable that the adding amount water soluble organic solvent is within the above described range, as there is no fear of swelling of toner parent particles in the dispersion liquid by organic solvent's act, and external additives cover uniformly and adhere with high adhering strength without affect the predetermined performance of the toner parent particles.

Dispersion liquid in which toner parent particles is dispersed can be prepared by employing the quaternary ammonium salt compound and water soluble organic solvent describe above. The external additives are effectively adhered to the surface of the toner parent particles in the dispersion liquid by employing the quaternary ammonium salt compound and water soluble organic solvent. The dispersion liquid can be prepared by generally known dispersion methods.

Practical example to prepare dispersion liquid dispersing toner parent particles usable in the invention is described below. For example, 100 parts by mass of toner parent particles is charged into surfactant aqueous solution which is obtained by dissolving 72 parts by mass of QUARTAMINE 86 W (stearyl trimethyl ammonium chloride 28% by mass aqueous solution, Product by Kao Corp.) in 1,000 parts by mass of deionized water. The dispersion liquid dispersing toner parent particles can be prepared by stirring the liquid for 30 minutes via magnetic stirrer or inserted stirring blade in a flask.

The dispersion liquid dispersing negative charged external additives used in the invention is described, next. There are methods to practice charging the external additives negative in the invention, one is for example, adding an anionic surfactant such as dodecylbenzenesulfonic acid into the dispersion liquid and the other is employing dispersion liquid external additives available from market such as colloidal silica dispersion liquid (inorganic microparticles dispersion liquid), as previously described.

The external additives can be negatively charged by adding the anionic surfactant to the dispersion liquid in the method of negatively charging by adding the anionic surfactant to the dispersion liquid. The practical examples of anionic surfactant capable of negatively charging include sodium dodecylbenzenesulfonate, sodium dodecyl sulfonate, α-olefin sulfonic acid salt, phosphoric acid ester and the like.

Here, a method to prepare dispersion liquid of hydrophobic treated silica is described as an example of the methods of negatively charging external additives by adding the anionic surfactant to dispersion liquid. Hydrophobic treated silica microparticles X24 (product by Shin-Etsu Chemical Co., Ltd.) in an amount of 3 g available from market and 2 g of sodium dodecylbenzenesulfonate are charged into 100 g of deionized water, and they are subjected to stirring and mixing process at 14,000 rpm for 30 minutes via TK Homomixer (manufactured by Tokushu Kika Kogyo Co., Ltd.). Dispersion liquid containing negatively charged silica microparticles can be obtained by such procedures.

Negatively charged external additives are available from a market for a method of employing the dispersion liquid of external additives available from market.

Practically, representative examples of colloidal silica dispersion liquid include SNOWTEXZL (manufactured by Nissan Chemical Industries, Ltd.: 40% by mass of aqueous dispersion liquid colloidal silica having average primary particle diameter of 100 nm) available from market.

In case of manufacturing the external additives dispersion liquid such as colloidal silica dispersion liquid without employing the market product, external additives contained therein can be negatively charged by adjusting pH of the dispersion liquid higher than isoelectric point by a known method. It is preferable to adjust pH of dispersion medium 4 or higher, for example, so as to negatively charge the silica particles when colloidal silica dispersion liquid is manufactured by oneself.

Practical example of the dispersion medium and the external additives which compose the dispersion liquid dispersing negative charged external additives is described.

Water is most preferable as the dispersion medium capable of using for dispersion liquid of the external additives.

The external additives capable of using in the invention are not particularly limited to as far as they are capable of negatively charging, and inorganic microparticles or organic microparticles which are used as the external additives of toner in general may be used. Practical examples include inorganic microparticles such as, silica, titania and alumina, and organic microparticles of a resin having different composition from a binder resin of the toner. Particles having hardness with small deformation by stress are preferable among these, and silica and titania are preferable.

Amount of the external additives is preferably 0.5 through 20% by mass based on mass of toner parent particle, and 1 through 10% by mass is more preferable.

The organic microparticles described above include, for example, polystyrene microparticles, polymethylmethacrylate microparticles, styrene-methylmethacrylate copolymer resin microparticles, polyurethane resin microparticles and the like. It is possible to employ organic-inorganic composite microparticles obtained by forming an inorganic layer on the organic microparticles with silica, titania and the like. Further, number based average particle diameter (average primary particle diameter) of the external additives is preferably 7 nm to 300 nm and more preferably 12 nm to 200 nm in view of ensuring spacer effect between toner particles and certain adhesion to surface of toner parent particles.

Further, it is preferable that the microparticles above described are subjected to hydrophobic treatment with silane coupling agent or titanium coupling agent. Degree of hydrophobic treatment is not particularly limited, and it is preferable to have methanol wettability of 40 through 95%. The methanol-wettability is a measure of wettability with methanol.

The methanol-wettability is measured as follows. Inorganic particles in an amount of 0.2 g to be measured are weighed out and added into 50 ml of distilled water in a 200 ml beaker. Methanol is gradually added with slowly stirring from a burette whose top is dipped in liquid until the entire inorganic particles are wetted. The degree of hydrophobicity is determined by the following formula:

Degree of hydrophobicity={a/(a+50)}×100

wherein “a” is the amount (ml) of methanol necessary to completely wet inorganic particles.

The dispersion liquid dispersing negative charged external additives can be mixed with the toner parent particles dispersion liquid by preferably dripping method, and the dripping rate is preferably 0.01 to 10 ml/min. Mixing temperature of the toner parent particles dispersion liquid with the dispersion liquid dispersing negative charged external additives is preferably not more than glass transition point of the toner parent particles dispersion to avoid coagulation of the toner parent particles.

### (Circularity of Toner Parent Particles)

An average circularity of toner parent particles used in the invention is described at first. The average circularity of toner parent particles used in the invention is preferably 0.850 to 0.990. That is, the shape of the toner parent particles can be selected those having no roundness with average circularity of 0.850 mainly manufactured via pulverization process, as well as those having roundness close to true sphere with average circularity of 0.990 which can be mainly manufactured via polymerization process in the invention.

Here, the average circularity of the toner parent particles is a value measured by employing FM-2100 (product by Sysmex Corp.).

The degree of average circularity of toner particles refers to a value determined using “FPIA-2100” (product by Sysmex Corp.), specifically, a value calculated as follows: a toner is wetted with an aqueous solution containing a surfactant, followed by being dispersed via ultrasonic dispersion treatment for 1 minute, and then photographed with “FPIA-2100” (product by Sysmex Corp.) in a measurement condition HPF (high magnification photographing) mode at an appropriate density of an HPF detection number of 3,000-10,000; the degrees of circularity of the individual toner particles are calculated based on Formula (2) described below; and the degree of circularity of each toner particle is added, and the resulting value is divided by the total number of the toner particles. The HPF detection number falling within the above range makes it possible to realize reproducibility.

Degree of circularity=(circumference length of a circle having the same projective area as a particle image)/(circumference length of the projective area of the particle) Formula (2)

The average circularity is an arithmetic average obtained by dividing sum of circularity of particles by total number of the measured particles.

Value of the average circularity of the toner parent particles described above coincides with the average circularity of the toner particles to which external additives have been add in the invention.

### (Particle Diameter of Toner Parent Particles)

Particle diameter of the toner parent particles used in the invention is described, next. It is preferable that the particle diameter of the toner parent particles used in the invention of 3 μm to 10 μm in terms of volume based median particle diameter (D₅₀). It is preferable that the particle diameter of the toner particles which have been subjected to external additives treatment of 3 μm to 10 μm in terms of volume based median particle diameter (D₅₀).

Very fine dot image, for example, 1200 dpi (dpi; number of dots per inch (2.54 cm)) level can be reproduced with fidelity by setting the volume based median particle diameter within above described range. Consequently, external additives do not release from surface of toner particles, fine dot image required to digital image forming can be prepared stably for long period by the previously described toner of the invention.

Volume based median particle diameter (D₅₀) of the toner parent particles can be measured and calculated by employing, for example, an apparatus of MULTISIZER 3 (product by Beckman Coulter Inc.) connected to computer system for data processing.

Specifically, after wetting 0.02 g of the toner parent particles into 20 ml of a surfactant solution (a surfactant solution obtained by diluting a neutral detergent containing a surfactant component by 10 times with water, for the purpose of dispersion of the toner parent particles, for example) to prepare the toner parent particles dispersion liquid via ultrasonic dispersion for one minute, the toner parent particles dispersion is charged into a beaker containing “ISOTON II” (manufactured by Beckman Coulter Inc.) set inside a sample stand by a pipette until concentration displayed by the measuring apparatus reaches 5 to 10%. The reproducible measured value can be obtained by setting to this concentration. The count number of measured particles and the aperture diameter are set to 25,000. The aperture size of the MULTISIZER 3 is set as 50 μm.

It is preferable that particle diameter ratio Dt/Db is 0.004 to 0.04, wherein Db is particle diameter of external additives and Dt is particle diameter of toner parent particles. The particle diameter of the toner parent particles Db is a volume based median particle diameter of the toner parent particles, and the particle diameter of external additives Dt is a number average primary particle diameter of the external additives.

A surfactant may be used in the aqueous medium in a preparation process of colorant microparticle dispersion or resin microparticles to disperse these microparticles stably. Various surfactants such as anionic surfactants, cationic surfactants, and nonionic surfactants can be used, and t anionic surfactants are preferably used.

The anionic surfactants include, for example, higher fatty acid salts such as sodium oleate; alkylaryl sulfonic acid salts such as sodium dodecylbenzenesulfonate; alkylsulfuric acid ester salts such as sodium laurylsulfate; polyoxyethylene alkyl ether sulfuric acid ester salts such as polyethoxyethylene lauryl ether sodium sulfate; polyoxyethylene alkyl aryl ether sulfuric acid ester salts such as polyoxyethylene nonyl phenyl ether sodium sulfate; alkylsulfosuccinic acid ester salts such as sodium monooctylsulfosuccinate, sodium dioctylsulfosuccinate, and polyoxyethylene sodium laurylsulfosuccinate; and derivatives thereof.

Dispersion of toner mother particles has preferably pH of 6 to 8 when it is prepared by emulsion polymerization aggregation process.

### (Production Method of Toner Parent Particles)

Subsequently, a production method of toner parent particles used in the invention is described.

The toner parent particles used in the invention are particles containing at least a binder resin and a coloring agent, composing parent body of the toner particles used for electrophotographic type image forming, and is generally called parent particles or colored particles. The toner parent particles used in the invention is not particularly limited, and can be prepared by known production methods of toner parent particles. Practically, there are a production method of toner parent particles so called pulverization process via kneading, crushing, and classification processes, and a production method so called polymerization process wherein particles are formed by polymerizing polymerizable monomers and simultaneously controlling particle shape or particle diameter.

It is preferable that the production process is conducted at a state maintaining the temperature of the kneaded material 130° C. or less when the toner parent particles are manufactured via pulverization process. This is because when temperature applied to the kneaded material excesses 130° C., aggregation state of a coloring agent in the kneaded material varies, and homogeneous aggregation state cannot be maintained by an action of the heat applied to the kneaded material. When the aggregation state is varied, color tone of the resulting toner is varied and there is a fear to cause color turbidity.

The production methods of toner parent particles via polymerization process include, for example, an emulsion polymerization process, a suspension polymerization process, polyester elongation method, emulsion polymerization aggregation method (also called emulsion polymerization association method) and the like. The emulsion polymerization aggregation method in which toner parent particles are prepared via process of aggregating and associating the prepared resin particles an emulsion polymerization obtained by emulsion polymerization is advantageous among these, as toner parent particles having homogeneous particle shape and diameter can be prepared and it is preferable because control ability of circularity of toner parent particles is good.

The aggregation process is described, which is a process of aggregating and fusing resin particles in the toner parent particles production process by emulsion polymerization aggregation method.

Dispersion liquid for aggregation process is prepared by mixing aqueous dispersion liquid of aqueous medium of resin particles, coloring agent particles, and wax particles, charge control agent particles as well as other toner ingredients, if necessary, in the aggregation process. The resin particles and coloring agent particles and the like are subjected to aggregating and fusing to form dispersion liquid of toner parent particles in the prepared dispersion liquid for aggregation.

Dispersion liquid for aggregation is subjected to salting by adding aggregation agent of critical aggregation concentration or more, and at the same time, subjected to stirring by means of reaction device having stirring blade, whereby the thermal fusing is conducted at glass transition point of resin composition or higher and particle diameter is allowed to gradually grow while forming aggregation particles, in detail. Growth of particle diameter is terminated when the particle reaches to targeted diameter, and further heating and stirring are continued to make the surface of particles smooth, and toner parent particles are formed by control the shape.

The aggregation agent is not particularly limited, and those selected from metal salts are used suitably. The example includes a salt of monovalent metal such as alkali metal, for example, sodium, potassium, and lithium, a salt of divalent metal such as calcium, magnesium, manganese and copper, a salt of trivalent metal such as iron and aluminum. Practically used salt includes, sodium chloride, potassium chloride, lithium chloride, calcium chloride, magnesium chloride, zinc chloride, copper sulfate, magnesium sulfate, manganese and the like, salt of divalent metal is particularly preferable among them. The divalent metal salt progresses aggregation with fewer amounts. The aggregation agent may be used singly or in plural combined.

It is preferable that time of standing after addition of aggregation agent (time prior to commencement of heating) is set as short as possible in aggregation process. It is preferable to start hating of the dispersion liquid for aggregation as quick as possible after addition of the aggregation agent to raise the temperature at higher than glass transition point of the resin composition. The reason is not clarified, but presumed there may raise a problem that aggregation state of the particles varies due to lapsing standing period, and particle diameter distribution of resulting toner parent particles becomes unstable, or surface property varies. The standing period is usually within 30 minutes and preferably within 10 minutes.

It is preferable to raise temperature quickly by heating in the aggregation process, and temperature raising rate is set as 15° C./minute or higher. The upper limit of temperature raising rate is not particularly limited, but 15° C./minute or lower is preferable in view of inhibiting the generation of course particles due to rapid progress of fusing. Further, it is important to maintain fusing by maintaining the temperature of said dispersion liquid for aggregation for certain time after temperature of the dispersion liquid for aggregation reaches glass transition point or higher. The growth and fusion of toner parent particles can be effectively progressed by this, and durability of toner parent particles finally obtained can be improved.

Coloring agents include carbon black, magnetic material, dye, pigment and the like, and these can be used arbitrarily. Example of usable carbon black include channel black, furnace black, acetylene black, thermal black, lamp black and the like. Example of magnetic material include ferromagnetic metal such as iron, nickel and cobalt, alloy containing these metals, ferromagnetic metal compound such as ferrite and magnetite, an alloy containing no ferromagnetic metal and displaying ferromagnetic property by thermal treatment, and the like. Example of the alloy containing no ferromagnetic metal and displaying ferromagnetic property by thermal treatment includes alloys of manganese-copper-aluminum, manganese-copper-tin as called Heusler's alloy, chromium dioxide and the like.

Example of the dye includes C.I. Solvent Red 1, Solvent Red 49, Solvent Red 52, Solvent Red 58, Solvent Red 63, Solvent Red 111, Solvent Red 122, C.I. Solvent Yellow 19, Solvent Yellow 44, Solvent Yellow 77, Solvent Yellow 79, Solvent Yellow 81, Solvent Yellow 82, Solvent Yellow 93, Solvent Yellow 98, Solvent Yellow 103, Solvent Yellow 104, Solvent Yellow 112, Solvent Yellow 162, C.I. Solvent Blue 25, Solvent Blue 36, Solvent Blue 60, Solvent Blue 70, Solvent Blue 93, Solvent Blue 95, and the like. Mixture of these dyes can be use.

Example of pigment includes C.I. Pigment Red 5, Pigment Red 48:1, Pigment Red 53:1, Pigment Red 57:1, Pigment Red 122, Pigment Red 139, Pigment Red 144, Pigment Red 149, Pigment Red 166, Pigment Red 177, Pigment Red 178, Pigment Red 222, C.I. Pigment Orange 31, Pigment Orange 43, C.I. Pigment Yellow 14, Pigment Yellow 17, Pigment Yellow 74, Pigment Yellow 93, Pigment Yellow 94, Pigment Yellow 138, Pigment Yellow 155, Pigment Yellow 180, Pigment Yellow 185, C.I. Pigment Green 7, C.I. Pigment Blue 15:3, Pigment Blue 60, and the like. Mixture of these dyes can be use. Number average primary particles diameter of the pigment varies depending on the species and is around 10 through 200 nm preferable in general.

Example of wax includes a hydrocarbon type wax such as low molecular weight polyethylene wax, low molecular weight polypropylene wax, Fischer-Tropsch wax, microcrystalline wax, and paraffin wax, and ester wax such as carnauba wax, pentaerythritol behenic acid ester, behenylbehenate, behenyl citrate. These can be employed solely or two or more in combination.

Content ratio of wax is 2 through 20% by mass of total mass of resin particles, and preferably 3 through 18%, more preferably 4 through 15% by mass.

Melting point of wax is preferably 50 through 95° C., in view of low temperature fixing property of the electrophotography and releasing property.

As the charge control agent composing a charge control agent particles, various one known in the art and available to dispersed in an aqueous medium can be usable. The example includes practically, nigrosine type dye, metallic salt of naphthenic acid or higher fatty acid, alkoxylated amine, a quaternary ammonium salt compound, azo type metal complex, salicylic acid metallic salt and its metal complex, and the like.

Number average primary particles diameter of the charge control agent particles is preferably around 10 through 500 nm in a dispersed state.

Dispersion liquid of coloring agent particles can be prepared by dispersing the coloring agent in an aqueous medium. It is preferable that the dispersion is conducted in a state that concentration of a surfactant is set critical micelle concentration or higher in dispersing process of the coloring agent in an aqueous medium, as the coloring agent is uniformly dispersed. Known dispersing machines can be used for dispersing process of the coloring agent. Known surfactants can be employed.

### (Other External Additives)

The other external additives can be added for controlling fluidity or charging performance furtherance to external additives particles added in an aqueous medium by a method showing below, in the invention. The method to adding external additives includes a dry process wherein powdered external additives are added to dried toner particles, and a mechanical mixing machine such as Henschel mixer, coffee mill and the like can be used.

### (Adhesion of External Additives)

Covering state and adhering state of the external additives adhered to surface of the toner particles prepared by the production method according to the invention described above are described. It is possible that the external additives uniformly cover surface of toner parent particles prepared via polymerization process by the toner production method according to the invention. Therefore, releasing of the external additives from the surface of toner parent particles is inhibited and stable image forming can be conducted without toner scattering or fogging due to charge leak caused by the release as surface of toner particles is uniformly covered with external additives particles and external additives particles are adhered with high adhering strength described later.

It is also possible that the external additives are adhered with high adhering strength to surface of toner parent particles prepared via polymerization process by the toner production method according to the invention. As the result, it is possible that the obtained toner displays excellent fluidity and charging performance, as shown in the evaluation result in Examples described later.

Here, the adhesion strength of external additives is degree of strength of adhesion performance of the external additives on the surface of toner parent particles. That is the term of adhesion of external additives used in the invention includes the fixation by adhesion performance caused by partial imbedding of external additives on the surface of toner parent particles in addition to adhesion performance by virtue of mutual attracting caused by electrostatic attraction between toner parent particles and external additives. Therefore, this means that the higher the value of the adhesion strength of external additives is, the adhesion strength of external additives to surface of toner parent particles is higher.

A preferable range of adhesion strength of external additives is 80% or higher, and more preferable range is 90% or higher. When the adhesion strength of the external additives is 80% or higher, there is no fear that external additives released from surface of toner particles, no problem occurs in reduction of charge quantity caused by transfer of released external additives to carriers or members of developing device.

The adhesion strength of external additives is conducted by measuring remaining ratio of external additives after applying predetermined vibration to the toner.

The adhesion strength of external additives can be obtained by the following procedure.

(1) Amount of external additives on the surface of toner particles is measured via measuring apparatus such as fluorescent X-ray analyzer.

(2) Ultra sonic wave is applied in water to the toner conducted above described measurement.

(3) Amount of external additives on the surface of toner particles to which the ultra sonic wave has been applied is measured.

Practical example of measuring adhesion strength of external additives is shown below.

(1) Toner in an amount of 4 g is provided, and amount of external additives of the toner is measured by a fluorescent X-ray analyzer available from market.

(2) Above described toner is charged into 40 g of 0.2% aqueous solution of sodium dodecylbenzenesulfonate so as to be wetted.

(3) Ultra sonic energy is applied to the above described toner in wetted state via a ultra sonic homogenizer US-1200T (frequency; 19.5 kHz, product by NISSEI Corporation.) to vibrate. In this instance, vibration is applied for 5 minutes while adjusting electric current indicating vibration added to the main apparatus to indicate 60 μA (50 W) of the ultra sonic homogenizer.

(4) After applying vibration, amount of the external additives is measured via fluorescent X-ray analyzer available from market.

(5) Adhesion strength vibration is calculated by inserting the amounts of external additives before and after vibration treatment into following Formula (3).

Adhesion ratio of external additives (%)=(amount of external additives after vibration treatment/amount of external additives before vibration treatment)×100 (Formula 3)

The toner produced by the production method according to the invention has the adhesion strength of external additives being 80% or more as shown in the Example described later.

### (Evaluation of Charging Performance and Fluidity)

Next, evaluation methods of charging performance and fluidity, which are methods to evaluate performance of the toner produced by the production method according to the invention, are described. The toner produced by the production method according to the invention can display good charging performance and fluidity as shown by evaluation result in Example described later. Evaluation methods of charging performance and fluidity are described below.

### 1. Evaluation Method Charging Performance

Example of methods to evaluate charging performance of the toner produced by the production method according to the invention includes a known charge quantity measuring method represented by a blow off measuring method and the like, and is not particularly limited. Here, a method to evaluate charging performance by electrolytic separation method, which is one of the charge quantity measuring methods, is described. The method measuring charge quantity of toner by electrolytic separation is conducted by the following procedure.

(1) toner produced by the production method according to the invention and standard carrier provided by the Imaging Society of Japan, Technology Committee are mixed so as to have toner mass ratio of 5.0% by mass to produce developer.

(2) 30 g of above described developer is charged into a 50 ml plastic bottle, the plastic bottle is rotated at 120 rpm for 20 minutes.

(3) One gram of the developer is set on a magnet roller from above described a plastic bottle, and counter electrodes whose mass is preliminary measured are set.

(4) Bias potential of 1 kV having the same polarity as the toner polarity is applied, and the magnet roller is rotated at 500 rpm for 1 minute in this state.

(5) Potential and mass between counter electrodes are measured after rotating above described magnet roller, and toner charge quantity Q/M (μC/g) is calculated by mass M (g) of toner attached to the counter electrodes and product of Q capacity of capacitor (1 μF) to potential between counter electrodes V.

The toner obtained by the production method according to the invention has charge quantity of 15 μC/g through 45 μC/g, and preferably 25 μC/g through 45 μC/g.

### 2. Evaluation Method of Fluidity

Subsequently, fluidity evaluation method of toner produced by the production method according to the invention is described. It is possible to evaluate fluidity of the toner, for example, by measuring transfer performance of the toner particles qualitatively in addition to a method of evaluating fluidity by image quality of formed image. Here, Toner Transfer Index which is one of methods evaluating fluidity by measuring transfer performance of toner particles is described.

The Toner Transfer Index is one of the methods to evaluate toner fluidity to evaluate fluidity via transfer performance of the toner and shows transfer performance of the toner numerically when controlled vibration is given to the toner. This means that Toner Transfer Index shows the fluidity of the moving toner particles, different from the fluidity evaluated by measuring static bulk density, angle of repose and the like of the toner particles in static state.

Toner Transfer Index can be measured by an apparatus called parts feeder, for example, disclosed in JP A 2004-10960.

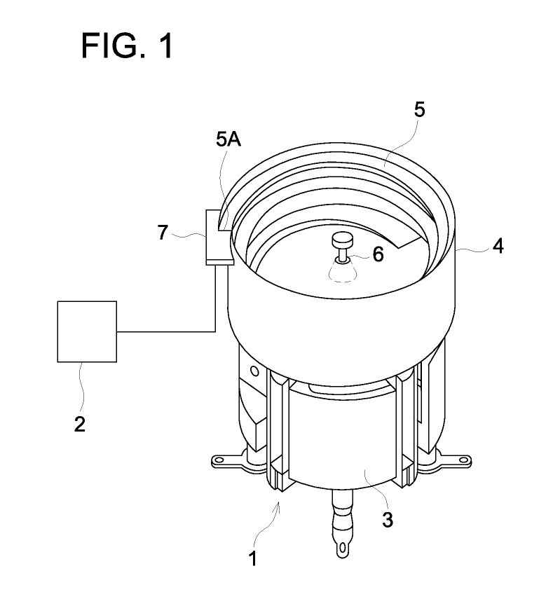

The parts feeder 1 comprises a driving source 3 for generating a specific vibration, and a cylindrical bowl 4 supported above the driving source 3, as shown in FIG. 1. The bowl 4 has a spiral slope way 5 formed on the inner circumferential wall thereof so as to connect the bottom plane to the upper end rim. The slope way 5 is disposed so that the upper end portion 5A thereof is projected out from the side wall of the bowl 4 outwardly in a radial direction at the same level of height as the upper end rim of the bowl. In FIG. 1, reference numeral 6 represents the center axis of the bowl 4, reference numeral 7 represents a pan disposed below the upper end portion 5A of the slope way 5, and reference numeral 2 represents a weighing means connected to the pan 7.

In this parts feeder 1, rotation power is supplied from the driving source 3 to the bowl 4 and is converted into vibratory motion for making the bowl 4 vibrate as a whole. By changing the limiting positions of the vertical motion with the action of springs disposed at angles, the toner placed in the bowl 4 is transferred upward along the slope way 5 and drop from the upper end portion 5A of the slope way 5 into the pan 7. Toner fluidity is evaluated by measuring mass of toner arriving at pan 7 within determined period from the toner supplied to around the center axis 6 of the bowl by parts feeder 1.

Practically procedure is;

(1) 1 g of the toner is put around the center axis 6 in the bowl 4;

(2) the operation started setting the driving source 3 at a frequency of 120 rps and a voltage of 80 V, so as to transfer the toner provided around the center axis of the bowl 4 by applying vibration;

(3) the durations of time between the start of operation of the driving source 3 and the points of time when the amount of the toner reached the pan 7 is 300 mg and 750 mg, respectively, are measured; and

(4) the transfer index is calculated by inserting the time to reach the above described toner amount into the Formula (4).

Transfer Index=(750−300) mg/(T750−T300) sec

This means that the transfer index is larger, that is, the difference of time taking the toner amount reaching to the pan of 300 mg and 750 mg is shorter, the higher the fluidity is. The smaller transfer index value is, the fluidity is lower to the contrary.

The toner can certainly obtain required chargeability and can realize the uniform mixing with carrier when transfer index of the toner of the invention is 2.0 or higher. The transfer index of the toner of the invention is 2.0 to 10.0, preferably 2.0 to 9.0, and more preferably 2.0 to 8.0.

### (Developer)

The toner obtained by the production method according to the invention can be used as a two component developer composed of carrier and toner as well as a nonmagnetic single component developer composed of toner solely. And when it is used as the double component developer, problems due to charge quantity variation caused by sticking of released external additives to the carrier surface is avoided as there is no fear that external additives are released from surface of toner particles by repeated friction with carrier. Further, when it is used as the single component developer, problems due to charge quantity variation caused by sticking of released external additives to the parts of a developer device is avoided as there is no fear that external additives are released by strong stress during thin layer forming in the developing process.

The carrier used as the double component developer is magnetic particles and it is possible to use known material, for example, metal such as iron, ferrite and magnetite, alloy of the metal and other metal such as aluminum and lead. Among these ferrite particles is preferable. The coated carrier covering magnetic surface of the particles with covering material such as resin, and resin dispersed type carrier dispersing magnetic material powder in a binder resin can be used as the carrier. Volume average particle diameter of the carrier is preferably 15 through 100 μm, and more preferably 25 through 80 μm.

### (Image Forming Method)

The toner obtained by the production method according to the invention is preferably used for an image forming method having plural transfer processes because external additives does not release by long time use and keep displaying spacer effect, described above.

Practical image forming apparatus includes charging means, exposing means, developing means by a developer including toner transferring means transferring the toner image formed by developing means to a transferee material via an inter transfer material provided on an electrostatic latent image bearing body (an electrophotographic photoreceptor representatively, and being referred to photoreceptor in abbreviate later). It is advantageous to use for a color image forming apparatus in which toner images on the photoreceptor are transferred to inter transferee material in sequence, a tandem type color image forming apparatus in which plural photoreceptors of different colors are arranged in series on an inter transferee material and the like.

### Example

The invention is described in concrete by means of examples.

### 1. Production of Toners 1 Through 13, and Comparative Toner 1 Through 4

### (Preparation of Toner Parent Particles)

### (Preparation of Resin Particles for Core Part 1)

Resin particles for core part 1 having multi-layer structure was prepared in the following procedure.

### (1) First Step Polymerization

Into a reaction vessel equipped with a stirring device, a temperature sensor, a condenser and nitrogen inlet, surfactant solution dissolving 4 parts by mass of sodium polyoxyethylene-2-dodecylether sulfonate in 3,040 parts by mass ion exchanged water, inside of temperature was raised to 80° C. under nitrogen gas stream with stirring at 230 rpm. Initiator solution in which 10 parts by mass of polymerization initiator (potassium persulfate:KPS) was dissolved in 400 parts by mass of ion exchanged water was added to the surfactant solution, after temperature was adjusted to 75° C., monomers mixture liquid composed of 532 parts by mass of styrene, 200 parts by mass of n-butylacrylate, 68 parts by mass of methacrylic acid, and 16.4 parts by mass of n-octylmercaptan was dripped for 1 hour, polymerization (First step polymerization) was conducted by heating the system at 75° C. with stirring for two hours and resin particles was prepared. This was called Resin Particles A1.

Weight average molecular weight (Mw) of Resin Particles A1 prepared by the First step polymerization was 16,500.

### (2) Second Step Polymerization (Forming Interlayer)

In a flask equipped with a stirring device 93.8 parts by mass of a releasing agent of paraffin wax HNP-57 (product by Nippon Seiro Co., Ltd.) was added to monomers mixture liquid composed of 101.1 parts by mass of styrene, 62.2 parts by mass of n-butylacrylate, 12.3 parts by mass of methacrylic acid, and 1.75 parts by mass of n-octylinercaptan, and monomer solution was prepared by heating to 90° C. and dissolving.

On the other side, surfactant solution obtained by dissolving 3 parts by mass of sodium polyoxyethylene-2-dodecylether sulfonate in 1,560 parts by mass of ion exchanged water was heated to 98° C., 32.8 parts by mass in terms of solid component of dispersion liquid of Resin Particles A1 was added to surfactant solution, then, above described monomer solution containing wax was subjected to dispersing by a mechanical dispersing device having circulation pass CLEARMIX (product by M Technique Co., Ltd.) for 8 hours, and dispersion liquid containing emulsified particles having dispersion particles diameter of 340 nm was prepared.

Subsequently, initiator solution obtained by dissolving 6 parts by mass of potassium persulfate in 200 parts by mass of ion exchanged water was added to the dispersion liquid, polymerization (Second step polymerization) was conducted by heating the system at 98° C. with stirring for 12 hours, and resin particles was prepared. This was called Resin Particles A2. Weight average molecular weight (Mw) of Resin Particles A2 prepared by the Second step polymerization was 23,000.

### (3) Third Step Polymerization (Forming Outer Layer)

Initiator solution obtained by dissolving 5.45 parts by mass of potassium persulfate in 220 parts by mass of ion exchanged water was added to Resin Particles A2 obtained as above described, monomers mixture liquid composed of 293.8 parts by mass of styrene, 154.1 parts by mass of n-butylacrylate and 7.08 parts by mass of n-octylmercaptan was dripped taking one hour at temperature condition of 80° C. After completion of dripping, polymerization (Third step polymerization) was conducted by heating with stirring for 2 hours, and it was cooled to 28° C. and Resin Particles for Core Part 1 was obtained. Weight average molecular weight (Mw) of Resin Particles for Core Part 1 prepared by the Third step polymerization was 26,800.

Volume average particle diameter of composite resin particles composing Resin Particles for Core Part 1 was 125 nm. Glass transition temperature (Tg) of the resin particles was 28.1° C. Glass transition temperature was measured by employing DSC-7 differential scanning calorimeter (product by PerkinElmer Co., Ltd.), TAC7/DX thermal analysis apparatus controller (product by PerkinElmer Co., Ltd.), data at 2nd Heat was taken.

### Resin Particles for Shell Layer

### (Preparation of Resin Particles for Shell Layer 1)

Resin Particles for Shell Layer 1 was prepared by the same method of polymerization and treatment thereafter as in First Step Polymerization of Resin Particles for Core Part 1 above described except that monomers mixture liquid was modified to be composed of 624 parts by mass of styrene, 120 parts by mass of 2-ethylhexyl acrylate, 56 parts by mass of methacrylic acid and 16.4 parts by mass of n-octylmercaptan.

### Preparation of Toner Parent Particles

### (Preparation of Coloring Agent Particles Dispersion Liquid 1)

Ninety parts by mass of sodium dodecyl sultanate was dissolved in 1,600 parts by mass of ion exchanged water by stirring. While stirring, 400 parts by mass of carbon black Mogul L (product by Cabot Corp.) was gradually add, subsequently, dispersing process was conducted by employing stirring device CLEARMIX (product by M Technique Co., Ltd.), Coloring Agent Particles Dispersion Liquid 1 was prepared

Particle diameter of coloring agent particles in Coloring Agent Particles Dispersion Liquid 1, measured by Electrophoretic Light Scattering Spectrophotometer (ELS-800, product by Otsuka Electronics Co., Ltd.) was 110 nm.

### (Salting/Fusing (Association/Fusing) Process) (Forming Core Part)

Resin Particles for Core Part 1 in an amount of 420 parts by mass (in terms of solid component) 900 parts by mass of ion exchanged water and 200 parts by mass of Coloring Agent Particles Dispersion Liquid 1 were charged into a reaction vessel equipped with a temperature sensor, a condenser, a nitrogen inlet and a stirring device, and stirred. After adjusting inside temperature at 30° C., aqueous solution of sodium hydroxide of 5 mol/L was added to the solution to adjust pH between 8 and 11.

Subsequently, aqueous solution obtained by dissolving 2 parts by mass of magnesium chloride hexa hydrate in 1,000 parts by mass of ion exchanged water, stirring was added at 30° C. taking 10 minutes. After standing for 3 minutes raising temperature was started and heated to 65° C. taking 60 minutes. Particle diameter of association particles was measured at that condition by Coulter Multisizer 3 (product by Beckman Coulter Inc.), when volume based median diameter of the particles (D₅₀) reached to 6.3 μm, aqueous solution obtained by dissolving 40.2 parts by mass of sodium chloride in 1,000 parts by mass of ion exchanged water was added to terminate growth of particle diameter, further, fusion was continued by heating and stirring for one hour at liquid temperature 70° C. to form Core Part 1.

Circularity of Core Part 1 Measured by FPIA-2100 (Product by Sysmex Corp.) was 0.920.

### (Forming Shell Layer (Shelling Operation))

Subsequently, 46.8 parts by mass of Resin Particles for Shell Layer 1 (in terms of solid component) was added at 65° C., further aqueous solution obtained by dissolving 2 parts by mass of magnesium chloride hexa hydrate in 1,000 parts by mass of ion exchanged water was added taking 10 minutes, temperature was raised to 70° C. (shelling temperature), stirring was continued for one hour, particles of Resin Particles for Shell Layer 1 were fused on surface of Core Part 1, and after that, shell layer was formed by ripening treatment at 75° C. so as to have predetermined circularity.

Here, 402 parts by mass of sodium chloride was added, it was cooled to 30° C. at a condition of then 8° C./minute, toner parent particles dispersion liquid 1 was obtained. Volume based median particle diameter (D₅₀) and circularity of toner parent part, respectively.

Production of toner particles 1 (Toner 1)

### (Preparation of External Additives Dispersion Liquid)

Hundred parts by mass of Silica microparticles RX200 (production by Nippon Aerosil Co., Ltd.) having number based average particle diameter (number average primary particle diameter) of 12 nm was charged into 1,900 parts by mass of aqueous solution of 2% by mass of surfactant dodecylbenzenesulfonic acid sodium, then ultra sonic dispersing process was conducted. The external additives dispersion liquid dispersing above described silica microparticles in above described surfactant aqueous solution was produced in such way.

### (External Additives Adhesion Process)

Aqueous solution of sodium hydroxide was added to 1,000 parts by mass of above described toner parent particles dispersion liquid 1 (solid ingredient of 10% by mass) with stirring so that pH of dispersion liquid was adjusted to 7.

Then, the following were added and stirred for 30 minutes.

| | |
|---|---|
| Lauryl trimethyl ammonium chloride solution, | 200 parts by mass |
| QUARTAMINE 24P (product by Kao Corp.) | |
| composed of 25% by mass of lauryl trimethyl | |
| ammonium chloride, 55% by mass of water and | |
| 20% by mass of isopropyl alcohol | |
| Isopropyl alcohol | 50 parts by mass |

Next, mixed liquid of toner parent particles dispersion liquid 1 and external additives dispersion liquid was produced by dripping 20 parts by mass of above described external additives dispersion liquid in toner parent particles dispersion liquid 1 prepared as described above, taking two hours keeping temperature at 20° C. After completion of dripping of above described external additives dispersion liquid, stirring process was continued two hours more so that external additives were adhered to surface of toner parent particles. Then, particles were separated from mixture liquid by solid liquid separation, they were subjected to rinsing with 6,000 parts by mass of ion exchanged water four times repeatedly, and Toner Particles 1 (Toner 1) was produced by drying process with warm wind at 40° C.

Production of toner particles 2 (Toner 2)

Toner Particles 2 (Toner 2) was produced by the same procedure as production of above described toner particles 1 (Toner 1), except that, surfactant to add to toner parent particles dispersion liquid 1 was replaced by 179 parts by mass of QUARTAMINE 86W obtained from market (Product by Kao Corp.), composed of 28% by mass of stearyl trimethyl ammonium chloride and 72% by mass of water.

### Production of Toner Particles 3 (Toner 3)

Toner Particles 3 (Toner 3) was produced by the same procedure as production of above described toner particles 1 (Toner 1), except that, surfactant to add to toner parent particles dispersion liquid 1 was replaced by 167 parts by mass of QUARTAMINE 60W obtained from market (Product by Kao Corp.), composed of 30% by mass of cetyl trimethyl ammonium chloride and 70% by mass of water.

### Production of Toner Particles 4 (Toner 4)

Toner Particles 4 (Toner 4) was produced by the same procedure as production of above described toner particles 2 (Toner 2), except that, amount of surfactant QUARTAMINE 86W to add to toner parent particles dispersion liquid 1 was modified to 36 parts by mass.

Production of toner particles 5 (Toner 5)

Toner Particles 5 (Toner 5) was produced by the same procedure as production of above described toner particles 2 (Toner 2), except that, amount of surfactant QUARTAMINE 86W to add to toner parent particles dispersion liquid 1 was modified to 714 parts by mass.

### Production of Toner Particles 6 (Toner 6)

Toner Particles 6 (Toner 6) was produced by the same procedure as production of above described toner particles 2 (Toner 2), except that, amount of isopropyl alcohol to add to toner parent particles dispersion liquid 1 was modified to 31 parts by mass.

### Production of Toner Particles 7 (Toner 7)

Toner Particles 7 (Toner 7) was produced by the same procedure as production of above described toner particles 2 (Toner 2), except that, amount of surfactant QUARTAMINE 86W and isopropyl alcohol to add to toner parent particles dispersion liquid 1 was modified to 200 parts and 380 parts by mass, respectively.

### Production of Toner Particles 8 (Toner 8)

Toner Particles 8 (Toner 8) was produced by the same procedure as production of above described toner particles 7 (Toner 7), except that, the external additives used in external additives dispersion liquid was modified to titania particles STT30S obtained from market (product by Titan Kogyo Ltd.) having number based average primary particle diameter (number average primary particle diameter) of 30 nm, and further amount of isopropyl alcohol to add to toner parent particles dispersion liquid 1 was modified to 90 parts by mass.

### Production of Toner Particles 9 (Toner 9)

Toner Particles 9 (Toner 9) was produced by the same procedure as production of above described toner particles 7 (Toner 7), except that, the external additives used in external additives dispersion liquid was modified to silica particles NAX50 obtained from market (product by Nippon Aerosil Co., Ltd.) having number based average primary particle diameter (number average primary particle diameter) of 20 nm.

### Production of Toner Particles 9 (Toner 9)

Toner Particles 9 (Toner 9) was produced by the same procedure as Production of above described toner particles 7 (Toner 7), except that, the external additives used in external additives dispersion liquid was modified to silica particles NAX50 obtained from market (product by Nippon Aerosil Co., Ltd.) having number based average primary particle diameter (number average primary particle diameter) of 20 nm, and further adding amount of isopropyl alcohol was modified to 100 parts by mass.

### Production of Toner Particles 10 (Toner 10)

Toner Particles 10 (Toner 10) was produced by the same procedure as Production of above described toner particles 7 (Toner 7), except that, water soluble organic solvent to add toner parent particles dispersion liquid 1 was changed to 100 parts by mass of methanol.

### Production of Toner Particles 11 (Toner 11)

Toner Particles 11 (Toner 11) was produced by the same procedure as Production of above described toner particles 7 (Toner 7), except that, water soluble organic solvent to add toner parent particles dispersion liquid 1 was changed to 100 parts by mass of acetone.

### Production of Toner Particles 12 (Toner 12)

Toner Particles 12 (Toner 12) was produced by the same procedure as Production of above described toner particles 2 (Toner 2), except that, the external additives dispersion liquid was changed to dispersion liquid of 40% by mass of colloidal silica having average primary particle diameter of 100 nm, SNOWTEX ZL (product by Nissan Chemical Industries, Ltd.), whose pH was adjusted to 4.

### Production of Toner Particles 13 (Toner 13)

### (Production of Toner Parent Particles 2)

| | |
|---|---|
| Polyester resin | 100 parts by mass |
| Carbon black (MOGUL L: product by Cabot Corp.) | 5 parts by mass |
| Low molecular weight poly propylene resin | 3 parts by mass |
| Additive (T-77: product by Hodogaya Chemical | 1 part by mass |
| Co., Ltd.) | |

The above described materials were preliminarily mixed by Henschel mixer (product by Mitsui Mining Co., Ltd.), then were subjected to melt kneading by a double-screw kneading extruder at 110° C. Resulted kneaded material was cooled and crushed roughly by a hummer mill (product by Hosokawa Micron Corp.), then crushed finely by employing a mechanical crushing apparatus, TURBO MILL T-400 (product by Turbo Corp.), classified by a wind classifier, and black toner parent particles 2 having volume average particle diameter of 9.5 μm and circularity of 0.852 was obtained.

Hundred parts by mass of above described toner parent particles 2 was dispersed in aqueous solution of a surfactant obtained by dissolving 179 parts by mass of QUARTAMINE 86W (28% by mass of stearyl trimethyl ammonium chloride aqueous solution: product by Kao Corp.) in 900 parts by mass of deionized water (1.9% by mass aqueous solution), and toner parent particles dispersion liquid 2 was prepared.

Toner particles 13 was Produced in the same way as Production method of toner particles 2 (Toner 2), except that above described toner parent particles dispersion liquid 2 was employed.

### Production of Comparative Toner Particles 1 (Comparative Toner 1)

Comparative toner particles 1 (Comparative toner 1) was produced by the same Production method of above described toner particles 1 (Toner 1), except that a surfactant to add to the toner parent particles dispersion liquid 1 was changed to 50 parts by mass of ACETAMIN 86 (Product by Kao Corp.) containing stearyl amine acetate obtained from market.

### Production of Comparative Toner Particles 2 (Comparative Toner 2)

Comparative toner particles 2 (Comparative toner 2) was produced by the same Production method of above described toner particles 1 (Toner 1), except that a surfactant to add to the toner parent particles dispersion liquid 1 was changed to 50 parts by mass of ACETA IN 24 (Product by Kao Corp.) containing coconut amine acetate obtained from market.

### Production of Comparative Toner Particles 3 (Comparative Toner 3)

Comparative toner particles 3 (Comparative toner 3) was produced by the same Production method of above described toner particles 1 (Toner 1), except that the water soluble organic solvent isopropyl alcohol to add to the toner parent particles dispersion liquid 1 was not added.

### Production of Comparative Toner Particles 4 (Comparative Toner 4)

Comparative toner particles 4 (Comparative toner 4) was produced by the same Production method of above described toner particles 1 (Toner 1), except that the surfactant QUARTAMINE 24P to add to the toner parent particles dispersion liquid 1 was not added.

Species and adding amount of the external additives dispersion liquid, the surfactant toner parent particles dispersion liquid 1 and the water soluble organic solvent used in the production of the above described Toner 1 through 13 and Comparative toner 1 through 4 are shown in Table 1.

TABLE 1

| | | | External additives | | | | Water soluble | | |
|---|---|---|---|---|---|---|---|---|---|
| | | | dispersion liquid | | Surfactant | | organic solvent | | |
| | Toner Parent particles | | | Amount | | Amount | | Amount | |
| | Preparation | | External | (parts by | | (parts by | | (parts by | |
| Toner No. | Process | Circularity | additives | mass) | Surfactant | mass) | Solvent | mass) | Remarks |
| Toner Particle 1 | Polymerization | 0.960 | RX200 | 20 | QUARTAMINE 24P | 200 | IPA | 90* | |
| | Process | | Dispersion | | | | | | |
| Toner Particle 2 | Polymerization | 0.960 | RX200 | 20 | QUARTAMINE | 179 | IPA | 90 | |
| | Process | | Dispersion | | 86W | | | | |
| Toner Particle 3 | Polymerization | 0.960 | RX200 | 20 | QUARTAMINE | 167 | IPA | 90 | |
| | Process | | Dispersion | | 60W | | | | |
| Toner Particle 4 | Polymerization | 0.960 | RX200 | 20 | QUARTAMINE | 36 | IPA | 90 | |
| | Process | | Dispersion | | 86W | | | | |
| Toner Particle 5 | Polymerization | 0.960 | RX200 | 20 | QUARTAMINE | 714 | IPA | 90 | |
| | Process | | Dispersion | | 86W | | | | |
| Toner Particle 6 | Polymerization | 0.960 | RX200 | 20 | QUARTAMINE | 200 | IPA | 31 | |
| | Process | | Dispersion | | 86W | | | | |
| Toner Particle 7 | Polymerization | 0.960 | RX200 | 20 | QUARTAMINE | 200 | IPA | 380 | |
| | Process | | Dispersion | | 86W | | | | |
| Toner Particle 8 | Polymerization | 0.960 | STT30S | 20 | QUARTAMINE | 200 | IPA | 90 | |
| | Process | | Dispersion | | 86W | | | | |
| Toner Particle 9 | Polymerization | 0.960 | NAX50 | 20 | QUARTAMINE | 200 | IPA | 100 | |
| | Process | | Dispersion | | 86W | | | | |
| Toner Particle 10 | Polymerization | 0.960 | RX200 | 20 | QUARTAMINE | 200 | methanol | 100 | |
| | Process | | Dispersion | | 86W | | | | |
| Toner Particle 11 | Polymerization | 0.960 | RX200 | 20 | QUARTAMINE | 200 | acetone | 100 | |
| | Process | | Dispersion | | 86W | | | | |
| Toner Particle 12 | Polymerization | 0.960 | SNOWTEX ZL | 20 | QUARTAMINE | 179 | IPA | 90 | |
| | Process | | | | 86W | | | | |
| Toner Particle 13 | Pulverization | 0.852 | RX200 | 20 | QUARTAMINE | 179 | IPA | 90 | |
| | Process | | Dispersion | | 86W | | | | |
| Comparative Toner | Polymerization | 0.960 | RX200 | 20 | ACETAMIN 86 | 50 | IPA | 90 | |
| Particle 1 | Process | | Dispersion | | | | | | |
| Comparative Toner | Polymerization | 0.960 | RX200 | 20 | ACETAMIN 24 | 50 | IPA | 90 | |
| Particle 2 | Process | | Dispersion | | | | | | |
| Comparative Toner | Polymerization | 0.960 | RX200 | 20 | QUARTAMINE | 179 | — | — | |
| Particle 3 | Process | | Dispersion | | 86W | | | | |
| Comparative Toner | Polymerization | 0.960 | RX200 | 20 | — | — | IPA | 90 | Scarcely |
| Particle 4 | Process | | Dispersion | | | | | | covered |

QUARTAMINE 24P: lauryltrimethyl ammonium chloride
QUARTAMINE 86W: stearyl trimethyl ammonium chloride
QUARTAMINE 60W: cetyltrimethyl ammonium chloride
ACETAMIN 86: stearyl amine acetate
ACETAMIN 24: coconut amine acetate
IPA: Isopropyl alcohol
*40 parts by mass was brought by surfactant solution

### 2. Evaluation

As for Toner 1 through 13 and Comparative toner 1 through 4 produced by the above described procedure adhesion state of the external additives, fluidity and charging performance were evaluated by the following procedure. Examples 1 through 13 show the evaluation of Toner 1 through 13 produced by the toner production method satisfying conditions of the invention and Comparative Examples 1 through 4 show the evaluation of Comparative Toners 1 through 4 produced by the toner production method not satisfying conditions of the invention the invention.

The evaluation was conducted at normal temperature and normal humidity environment of 20° C. and 55% RH, and the adhesion strength of external additives for the evaluation of adhesion state of the external additives on the surface of toner particles, Toner Transfer Index for the evaluation of toner fluidity and charge quantity (Q/M) for the evaluation toner charging performance were evaluated.

### Adhesion Strength of External Additives

Adhesion strength of external additives of each toner was calculated by the method described previously, the ample having strength of 80% or more was ranked acceptable, and not less than 80% was not acceptable. Table 2 described later shows the value of the external additives adhesion strength of each toner, as well as ranks A and B for acceptable sample according to the strength value of 90% or more, and between 80% and 90%, respectively, and C for not acceptable sample.

### Fluidity

Fluidity of toner was evaluated by means of transfer index. Toner transfer index was calculated by the procedure described previously, and the sample having value of less than 12.0 was ranked acceptable and 12.0 or more was ranked not acceptable. Table 2 described later shows the value of the toner transfer index of each toner, as well as ranks A and B for acceptable sample according to the strength value of less than 8%, and between 8% and 12%, respectively, and C for not acceptable sample.

### Charging Performance

Charging performance of toner was evaluated via charge quantity (Q/M) by means of the above described electrolytic separation method. Charge quantity was measured and calculated according to the previously described. Samples having charge quantity of 15 μC/g or more was ranked acceptable and less than 15 μC/g not acceptable. Table 2 shows the value of the charge quantity of each toner, as well as ranks A and B for acceptable sample according to the charge quantity of 25 μC/g or more, and between 15 μC/g and 25 μC/g, respectively, and C for not acceptable sample.

TABLE 2

| | Adhesion | | | | | |
|---|---|---|---|---|---|---|
| | of external | | | | | |
| | additives | | | | Charging | |
| | Adhesion | | Fluidity | | performance | |
| | strength | | Transfer | | Q/M | |
| Toner No. | (%) | Rank | Index | Rank | (μC/g) | Rank |
| Toner Particle 1 | 98 | A | 2.5 | A | 38.8 | A |
| Toner Particle 2 | 97 | A | 2.8 | A | 32.1 | A |
| Toner Particle 3 | 95 | A | 3.1 | A | 26.3 | A |
| Toner Particle 4 | 92 | A | 10.9 | B | 24.2 | B |
| Toner Particle 5 | 83 | B | 9.8 | B | 21.1 | B |
| Toner Particle 6 | 80 | B | 7.5 | A | 18.9 | B |
| Toner Particle 7 | 99 | A | 11.7 | B | 15.5 | B |
| Toner Particle 8 | 85 | B | 3.3 | A | 16.2 | B |
| Toner Particle 9 | 95 | A | 6.2 | A | 42.1 | A |
| Toner Particle 10 | 82 | B | 3.5 | A | 24.8 | B |
| Toner Particle 11 | 99 | A | 11.2 | B | 18.6 | B |
| Toner Particle 12 | 82 | B | 11.5 | B | 22.6 | B |
| Toner Particle 13 | 91 | A | 6.7 | A | 27.7 | A |
| Comparative | 64.2 | C | 13.8 | C | 11.2 | C |
| Toner Particle 1 | | | | | | |
| Comparative | 56.1 | C | 18.2 | C | 8.9 | C |
| Toner Particle 2 | | | | | | |
| Comparative | 12.1 | C | 24.5 | C | 13.2 | C |
| Toner Particle 3 | | | | | | |
| Comparative | 0.2 | C | 56.2 | C | 4.2 | C |
| Toner Particle 4 | | | | | | |

Toners 1 through 13 produced by the production method according to the invention show good results in any evaluation items of external additives adhesion strength, toner transfer index and charge quantity. On the other side, Comparative Toners 1 through 4 produced by the production method not according to the invention show poor results.

1. A production method of a toner for developing an electrostatic image, the toner comprising toner parent particles and external additives adhered to a surface of the toner parent particles, wherein the method comprises steps of;
preparing toner parent particles dispersion liquid in which toner parent particles are dispersed in a medium,
first mixing the dispersion liquid with a quaternary ammonium salt compound and a water soluble organic solvent to prepare liquid mixture, and
second mixing the liquid mixture with external additive dispersion liquid in which negative charged external additives are dispersed.

2. The production method of claim 1, wherein the toner parent particles are formed by aggregating and fusing in an aqueous medium in which the resin particles are formed by polymerizing polymerizable monomers in an aqueous medium.

3. The production method of claim 1, wherein the external additive dispersion liquid contains an anionic surfactant.

4. The production method of claim 1, wherein the water soluble organic solvent has lower dielectric constant than that of water.

5. The production method of claim 1, wherein an amount of the water soluble organic solvent is not less than 3% and not more than 30% by mass based on dispersion medium of the toner parent particles dispersion liquid.

6. The production method of claim 5, wherein an amount of the water soluble organic solvent is not less than 5% and not more than 20% by mass based on dispersion medium of the toner parent particles dispersion liquid.

7. The production method of claim 1, wherein an amount of the quaternary ammonium salt compound is not less than 1% and not more than 20% by mass based on dispersion medium of the toner parent particles dispersion liquid.

8. The production method of claim 7, wherein an amount of the quaternary ammonium salt compound is not less than 3% and not more than 10% by mass based on dispersion medium of the toner parent particles dispersion liquid.

9. The production method of claim 1, wherein a particle diameter ratio Dt/Db is 0.004 to 0.04, wherein Db is a volume based median particle diameter of the toner parent particles, and Dt is a number average primary particle diameter of the external additives.

10. The production method of claim 1, wherein the method further comprises after mixing step, a step of stirring the liquid obtained by the mixing step so that the toner particles have adhesion strength of external additives is 80% or higher.

11. The production method of claim 1, wherein the dispersion liquid is mixed with a quaternary ammonium salt compound and then with a water soluble organic solvent.

12. The production method of claim 1, wherein the toner parent particles contain a coloring agent.
